(19) United States
(12) Patent Application Publication
(10) Pub. No.: US 2009/0144121 A1
(43) Pub. Date: Jun. 4, 2009

(54) Pandemic Cross Training Process

(75) Inventors: Nelson J. Chevis, Highland Village, TX (US); Timothy Edward Gorczyca, Allen, TX (US); Mian Zhou, Dallas, TX (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/948,735

(22) Filed: Nov. 30, 2007

(51) Int. Cl. G06Q 10/00

(52) U.S. Cl. 705/9; 705/7

(57) ABSTRACT

The disclosure relates to a process which determines a cross-training plan in order to ensure a company or business unit will be better prepared for a pandemic event by cross-training additional employees in the most critical services or functions. The pandemic cross-training plan is determined by utilizing such criteria such as geography, experience-level, and employee preference to strategically and systematically cross-train an employee in a critical function. This can be completed either manually through a criteria matrix approach or automatically by a computing device and utilizing mathematical formulas.

### FIELD OF THE INVENTION

The disclosure generally relates to business continuity planning and more particularly a process which determines a cross-training plan in order to ensure a company or business unit will be better prepared for a pandemic event by cross-training additional employees in the most critical services or functions.

### BACKGROUND

Normal business continuity pandemic plans require business units to identify critical employees, teams, and/or services to ensure backups are available, preferably in alternate cities, to ensure redundancies.

The normal plan is to ensure the most critical services will be covered if up to 50% of human resources are unavailable for up to three months. However, normal planning falls short if all employees on the most critical teams are unavailable.

Furthermore, these normal plans are not automated and can be subjective and difficult to manage because of the manual process.

### BRIEF SUMMARY

Aspects of the present disclosure address one or more of the issues mentioned above by disclosing methods, systems and computer readable media for determining a pandemic cross-training plan. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one embodiment, the business unit's senior management team analyzes the business unit's services or functions and ranks them by importance and criticality. This analysis can be done manually or automatically by a computing device through the use of a criticality score. In another embodiment, these functions or services are divided into critical and non-critical functions or services automatically by the computing device and the criticality score.

In a further embodiment, the pandemic cross-training plan is determined by utilizing such criteria such as geography, experience-level, and employee preference to strategically and systematically develop a training plan to cross-train an employee in a critical function. This can be completed either manually through a criteria matrix approach or automatically by a computing device and utilizing mathematical formulas.

Aspects of the invention may be provided in a computer-readable medium having computer-executable instructions to perform one or more of the process steps described herein.

These and other aspects of the disclosure are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosure may be implemented;

FIG. 2 illustrates an embodiment of an overall process for pandemic cross training; and

FIG. 3 illustrates another embodiment of an overall process for pandemic cross training using a mathematical matrix.

### DETAILED DESCRIPTION

The process discussed below ensures that a corporation, company, or business unit will be better prepared for a pandemic event by cross-training additional employees or teams in the most critical service delivery areas. This process is not limited to pandemic events. Those skilled in the art will recognize that this process can be beneficial in the event of other disruptions such as natural disasters (hurricanes, floods, fires, tornadoes, ice storms, and earthquakes, etc.), power outages, terrorism attacks, biological threats, etc.

The invention may be described in the general context of computer-executable instructions, such as program modules, being executed by a computer. Generally, program modules include routines, programs, objects, components, data structures, etc. that perform particular tasks or implement particular abstract data types. The features of the present application may be practiced either in a local computing device or in a distributed computing environment where tasks are performed by remote processing devices that are linked through a communications network. In a distributed computing environment, program modules may be located in both local and remote computer storage media including memory storage devices.

Illustrative Computing System Environment

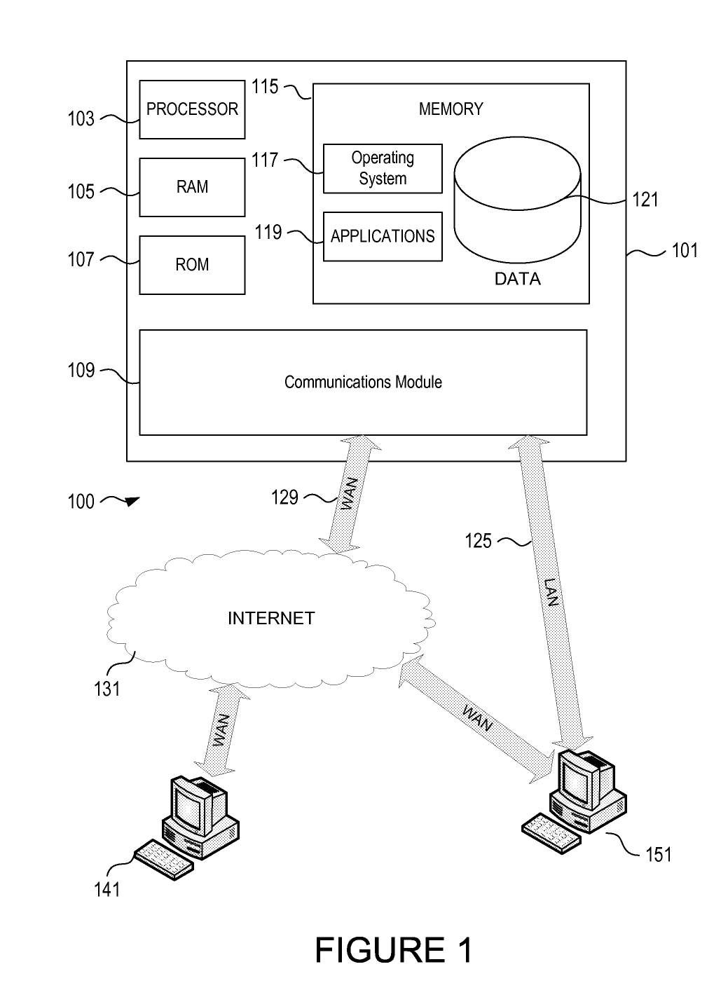

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random access memory (RAM) 105, read only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise and combination of computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and an output device, such as a printer or video display device, for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). As described in detail below, the database 121 may provide centralized storage of account information and account holder information for the entire business, allowing interoperability between different elements of the business residing at different physical locations.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. One or more branch computing devices 141 and 151 may serve as a shared system wherein detected incidents of non-public information having been stored in memory may be reported for subsequent analysis (discussed herein).

The network connections depicted in FIG. 1 include a local area network (LAN) 125 and a wide area network (WAN) 129, but may also include other networks. When used in a LAN networking environment, computing device 101 is connected to the LAN 125 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment of the invention, may include computer executable instructions for invoking user functionality related to communication including, for example, email, short message service (SMS), and voice input and speech recognition applications.

Illustrative Processes for Pandemic Event Cross Training

As discussed, the features of the present application may be practiced either in a local computing device or in a distributed computing environment. In one embodiment, the features of the present application may be implemented in the form of a software agent in a local computing device.

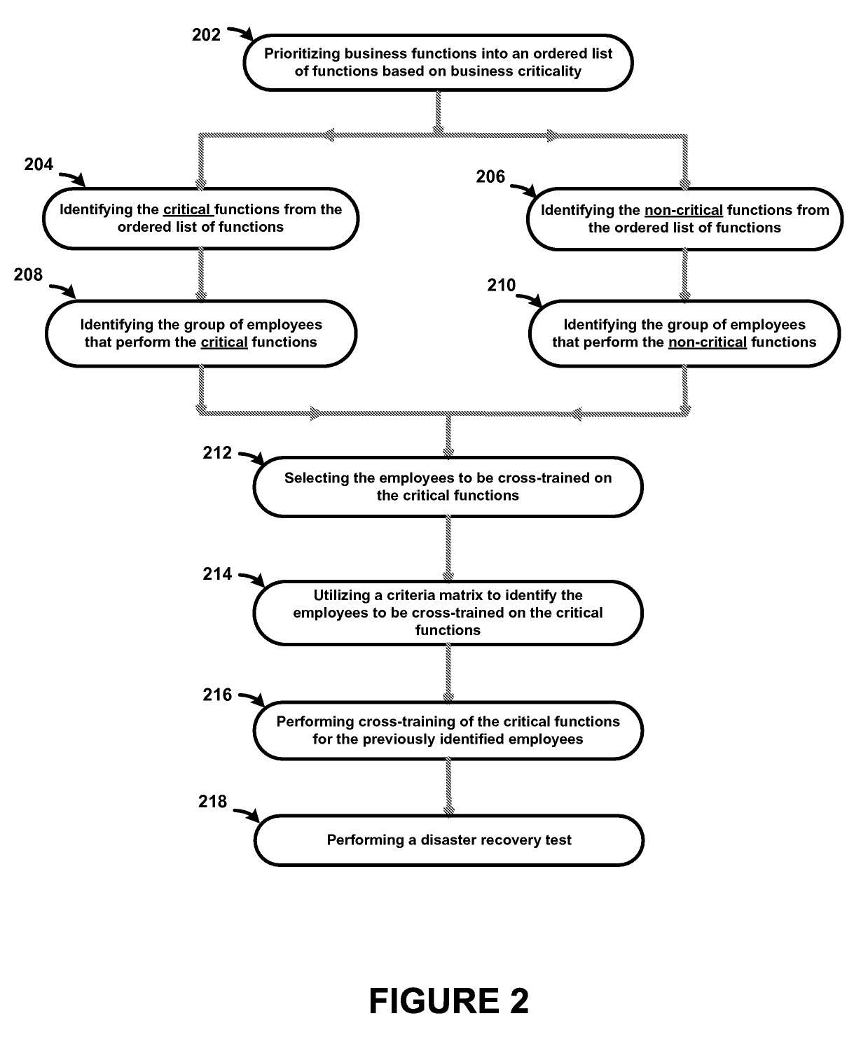

FIG. 2 shows a flow chart illustrating an illustrative method for a process for pandemic event cross training. At step 202, each of the identified services or functions within a business entity or business unit are prioritized or rank ordered. This prioritization of services or functions may be based at least in part on a business criticality evaluation. In one aspect, this prioritization can be completed by the business unit's senior management team or equivalent. The business unit's senior management team or equivalent perform the business criticality evaluation by, for example, analyzing the business unit's service offerings and ranking these services or functions by importance and/or criticality. The criteria for determining the importance or criticality of a service or function can vary greatly from business unit to business unit. One of the most important criteria may be the impact to the corporation if a particular service or function is interrupted or cannot be provided. Some other illustrative criteria may include: any service or function that involves direct customer impact of any kind, any service or function that provides company security, any service or function that mitigates threats or reduces a significant amount of risk, any services or functions that avoid significant impact to the corporation's financial statement, any service or function that provides customer service, any service or function that ensures the corporation can meet their legal obligations, any service or function that may compromise the corporation's reputation.

In various aspects of this invention, the prioritization may be performed by the computing device 101 utilizing the above criteria or additional criteria. A user may enter the criteria and rank the criteria. The user may also enter the services or functions and whether each of these meet the previously entered criteria. The system then performs the calculations to determine a criticality score and then rank these services or functions based at least in part on the criticality score and/or the user-entered information. This prioritization may then be reviewed by senior management in order to move forward to the next step of the process.

At steps 204 and 206, those critical and non-critical services or functions are identified from the ordered list of functions. In one aspect of the invention, this may be done manually by the business unit management team or equivalent in which case the management team may divide the list of services or functions into critical and non-critical services. When determining the division of these services or functions, the following may be considered: employee or team locations and business unit balance; in the event of a pandemic, a team could lose up to 50% of their staff for up to three months; employees or teams that may be in areas prone to natural disasters (hurricanes, flooding, ice storms, tornadoes, earthquakes, fires, etc.) One of skill in the art will appreciate that other considerations may be used in accordance with aspects of the invention after review of the entirety disclosed herein.

In various aspects of the invention, the computing device 101 may perform steps 204 and 206 by using a user-defined value for the threshold criticality score. Those services or functions with a criticality score higher than the threshold criticality score may be deemed critical services or functions. Those services or functions with a criticality score lower than the threshold criticality score may be deemed non-critical services or functions. As with the previous step, this identification may then be reviewed by senior management in order to move forward to the next step of the process.

In steps 208 and 210, employees or teams are identified that perform the critical and non-critical services or functions.

In step 212, employees or teams are selected to be cross-trained on the critical functions based at least in part on the identification of employees or teams that perform non-critical functions or services.

In step 214, pre-determined, user-selected trainee placement criteria may be used to identify the employees to be cross-trained on the critical functions. In an illustrative aspect of the invention, various criteria may be assessed when selecting these employees. Some examples of trainee criteria include, but are not limited to, the following: geography, experience-level, and/or preference. One skilled in the art will appreciate that other trainee placement criteria may be used in accordance with various aspects of the invention after review of the entirety disclosed herein. For geography in one example, you may consider cross-training employees in alternate cities because having two employees that can perform the same critical job service or function in two different cities greatly increases your chances of business continuity in the event of a pandemic event or disaster. Experience-level may be important because the employees may already have experience in one of the critical services or functions that they normally do not work in and therefore, training time may be greatly reduced if the associate has done a similar job function before. If a person has a preference or interest in a critical job function or service, cross training in that specific service or function may be smoother. Step 214 may be completed using a trainee criteria matrix in order to mathematically determine the criteria allocation of critical functions.

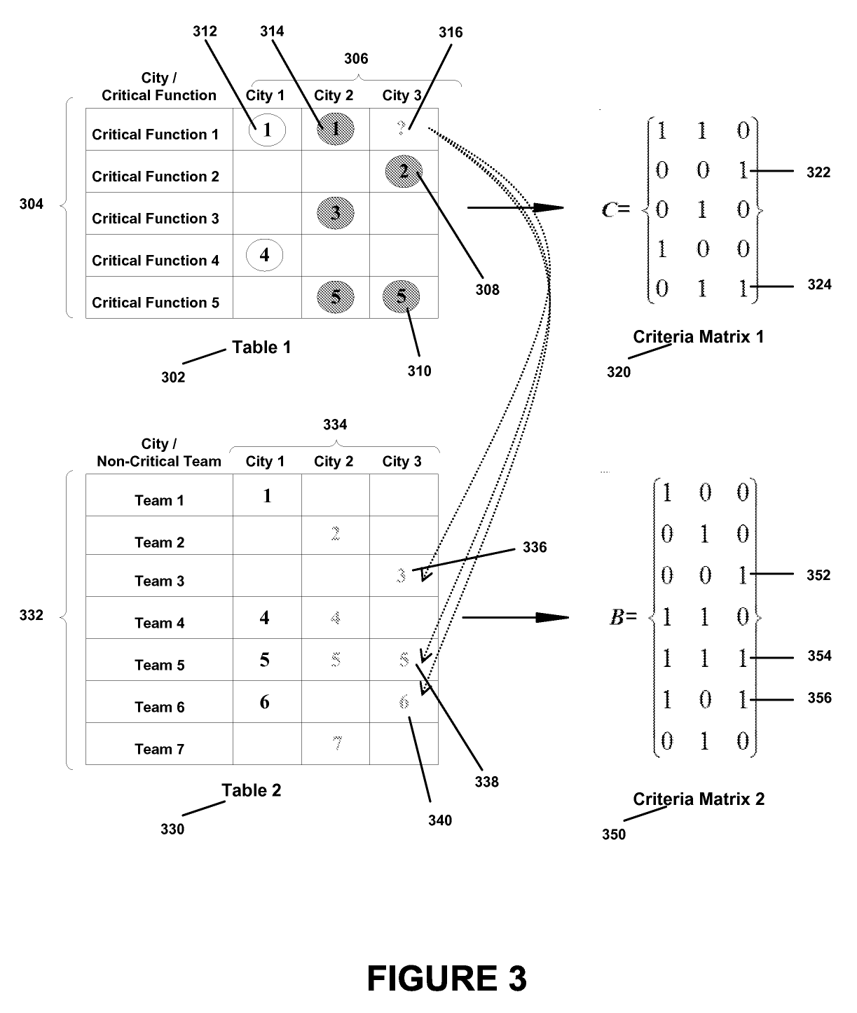

FIG. 3 illustrates another embodiment in accordance with various aspects of the invention. In this example, geography is used as the criteria for cross-training planning with the goal being to distribute the critical functions to as many cities as possible so that there is geographical back-up in case of a disaster in one or more of the cities. In table 1 302, the critical functions 1-5 304, are listed down the left side of the table, which are the critical functions identified in step 204. Further, in table 1 302, the cities 1-3 306 are listed on the top. The critical functions 304 which are performed in a city 306 are marked with the critical function number. For example, critical function two and five are performed in City 3, as marked by the two (2) 308 and five (5) 310, while critical functions one, three, and four are not performed in City 3, as shown by the void in each of those locations. A trainee criteria matrix 1 320 may be created by placing a one (1) in each of the matrix locations corresponding to table 1 302. For example, for City 3, a one (1) is placed in column three, row two 322 for critical function two at City 3 and column three, row five 324 for critical function five at City 3. Because none of the other critical functions are performed in City 3, zeros (0) are entered in the remaining rows in column three.

In table 2 330, the teams 1-7 332, are listed down the left side of the table, which are the non-critical teams identified in step 210. Further in table 2 330, the cities 1-3 334 are listed on the top. The non-critical teams which are located in each of the cities are marked with the team number. For example, team three, five, and six are located in City 3, as marked by the three (3) 336, five (5) 338, and six (7) 340, while teams one, two, four, and seven are not located in City 3, as shown by the void in each of these locations on the table. A trainee criteria matrix 2 350 may be created by placing a one (1) in each of the matrix locations corresponding to table 2 330. For example, for City 3, a one (1) is placed in column three, row three for team three, in column three, row five for team five, and column three, row six for team six. Because none of the other teams are located in City 3, zeros (0) are entered in the remaining rows in column three.

In order to determine those non-critical teams and their cross-training plan, the user may utilize table 1 302 and table 2 330 to assist them. The gaps in the availability to perform each critical function for each city are shown in table 1 302 by a void in that section of the table. The user can then utilize table 2 330 to determine which non-critical teams are located in each city. The user can then determine the cross-training plan for those non-critical teams in each of the cities. For example, in table 1 302 for critical function 1, critical function 1 is being performed in City 1 312 and City 2 314, however, not in City 3 316. In table 2 330, teams three 336, five 338, and six 340, are the non-critical teams in City 3. Therefore, teams three 336, five 338, and six 340 may be selected to cross-train on critical function 1 in order to fill the gap for City 3 and critical function 1 316.

One skilled in the art will appreciate that this trainee criteria matrix can be used for other criteria, such as experience-level and employee preference, or any other criteria that is selected in accordance with various aspects of the invention after review of the entirety disclosed herein.

In another embodiment of the invention, table 1 302, table 2 330, criteria matrix 1 320, and criteria matrix 2 350 can be represented mathematically, and therefore automatically determined by a computing device 101 by utilizing the following formulas:

Assumptions:
Number of critical functions is N
Number of city is K
Number of available non-critical teams is M

Matrix C represents the geography allocation of critical functions;

$$C = \{ \begin{matrix}{C}_{1 , 1} & {C}_{1 , 2} & … & {C}_{1 , k} \\ {C}_{2 , 1} & {C}_{2 , 2} & … & {C}_{2 , k} \\ … & & & \\ {C}_{n , 1} & {C}_{n , 2} & … & {C}_{n , k}\end{matrix} \}$$

Where C_{i,j} represents the critical function i located at city j. Where:

iε{1, . . . N}, j ε{1, . . . K}

$$B = \{ \begin{matrix}{B}_{1 , 1} & {B}_{1 , 2} & … & {B}_{1 , k} \\ {B}_{2 , 1} & {B}_{2 , 2} & … & {B}_{2 , k} \\ … & & & \\ {B}_{m , 1} & {B}_{m , 2} & … & {B}_{m , k}\end{matrix} \}$$

Where B_{x,y} represents the non-critical back team x located at city y. Where:

$$x ∈ \{ 1 , … M \} , y ∈ \{ 1 , … K \}$$

$$For ∀ i , if {\sum }_{j = 1}^{K} {C}_{i , j} < K$$

means if the critical function i is not fully covered by all K cities, then we need to find back up team from B, if there exists such solution, so that critical function i can be performed at all city. That is,

$${⋃}_{{C}_{i , x} != 0} \{ x \} + {⋃}_{{B}_{j , y} != 0} \{ y \} = \{ 1 , … k \}$$

One skilled in the art will appreciate that this mathematical determination can be used for other criteria, such as experience and preference, or any other criteria that is selected in accordance with various aspects of the invention after review of the entirety disclosed herein.

In step 216, and once the employees or teams have been identified for cross-training, a training program may be developed. Some tasks that may be performed during this step 216 are, auditing the most critical processes, determining training scope, developing or updating documentation, implementing a system access plan, and performing on-the-job training. When auditing the most critical processes, the user may be perform an audit of the most critical job functions in order to ensure the process flow is well-defined and accurate. When determining the training scope, the user may ensure the cross-training effort is focused on business continuity of the most critical job functions and deliverables and to make sure the curriculum does not spend too much time on less critical activities. The training coordinator should consider that every job detail does not need to be learned if it is not pertinent. All documentation may be audited to ensure accuracy, to include critical functions and process flow diagrams. Training materials may be created and/or updated accordingly. All system access to critical systems may be determined prior to the training. This may include, but not limited to, in certain cases it is not always practical to give several trainees full access to a critical system, determine if limited or temporary access is sufficient for training purposes, and consider only giving a few key employees in strategic locations permanent full access. Finally, trainees may receive on-the-job training to further enhance the employee training.

The final step 218, is to perform a disaster recovery test. Once cross-training has been completed, or periodically, the user may perform a full-scale live disaster recovery test to ensure teams are prepared and ready. Following the disaster recovery test, the user may review and analyze the lessons learned and make any necessary adjustment to the cross-training process.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the disclosure is contemplated. For example, aspects of the method steps disclosed herein may be executed on a processor on a computing device 101. Such a processor may execute computer-executable instructions stored on a computer-readable medium.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A method for preparing a business entity for a catastrophic event, wherein the business entity is associated with a plurality of functions, the method comprising:
prioritizing the plurality of functions into an ordered list of functions;
identifying a plurality of critical functions from the ordered list of functions;
selecting a plurality of employees to be cross-trained on the critical functions; and
performing cross training on the plurality of critical functions for the plurality of employees to be cross-trained.

2. The method of claim 1, wherein prioritizing the plurality of functions is based at least in part on a business criticality evaluation.

3. The method of claim 1, wherein said ordered list of functions is determined based on a list of criteria.

4. The method of claim 3, wherein said list of criteria is determined based on the criticality to the business functionality.

5. The method of claim 1, wherein a plurality of non-critical functions comprises the functions not selected as the critical functions.

6. The method of claim 1, further including the step of identifying a first group of employees wherein the first group of employees performs the critical functions.

7. The method of claim 1, further including the step of identifying a second group of employees wherein the second group of employees performs the non-critical functions.

8. The method of claim 7, further including the step of identifying the employees performing the non-critical functions.

9. The method of claim 1, further including the step of utilizing at least one criteria matrix to determine the employees to be cross-trained on the critical functions.

10. The method of claim 9, wherein the criteria matrix comprises at least one of such criteria as experience level, preference, and/or geography.

11. The method of claim 1, further including the step of performing a disaster recover test, wherein the disaster recovery test evaluates the effectiveness of the cross training on the critical functions for the employees to be cross-trained.

12. A computer-readable medium having computer-executable instruction for performing steps comprising:
prioritizing a plurality of functions into an ordered list of functions;
identifying a plurality of critical functions from the ordered list of functions;
identifying a plurality of non-critical functions from the ordered list of functions;
identifying a first group of teams wherein the first group of teams performs the critical functions;
identifying a second group of teams wherein the second group of teams performs the non-critical functions;
selecting a plurality of teams to be cross-trained on the critical functions;
mathematically determining the teams to be cross-trained on the critical functions by utilizing at least one criteria matrix.

13. The computer-readable medium of claim 12, wherein the computer-executable instructions are configured to be initiated by a user of the computing device.

14. The computer-readable medium of claim 12, wherein prioritizing the plurality of functions is based at least in part on a business criticality evaluation.

15. The computer-readable medium of claim 12, wherein the criteria matrix comprises at least one of such criteria as experience level, preference, and/or geography.

16. An apparatus, wherein a business entity is associated with a plurality of functions, the apparatus comprising:
an output device;
a memory;
a processor coupled to the memory and programmed with computer-executable instruction for performing steps comprising:
prioritizing the plurality of functions into an ordered list of functions;
identifying a plurality of critical functions from the ordered list of functions, wherein a plurality of non-critical functions comprises the functions not identified as the critical functions;
utilizing at least one criteria matrix to determine the teams to be cross-trained on the critical functions;
selecting a plurality of teams to be cross-trained on the critical functions.

17. The apparatus of claim 16, wherein prioritizing the plurality of functions is based at least in part on a business criticality evaluation.

18. The apparatus of claim 16, further including the step of identifying a first group of teams wherein the first group of teams performs the critical functions.

19. The apparatus of claim 16, further including the step of identifying a second group of teams wherein the second group of teams performs the non-critical functions.
